(19) United States
(12) Patent Application Publication
(10) Pub. No.: US 2004/0228763 A1
(43) Pub. Date: Nov. 18, 2004

(54) Apparatus for positioning objects

(76) Inventors: Nikolaus Ingenhoven, Maennedorf (CH); Markus Wiggli, Tann (CH); Adi Zuppiger, Siebnen (CH)

Correspondence Address: NOTARO AND MICHALOS, 100 DUTCH HILL ROAD, SUITE 110, ORANGEBURG, NY, 10962-2100, US

(21) Appl. No.: 10/842,092

(22) Filed: May 10, 2004

(30) Foreign Application Priority Data
May 14, 2003 (CH) 2003 0839/03

(51) Int. Cl. G01N 35/00

(52) U.S. Cl. 422/63

(57) ABSTRACT

An apparatus (1) for positioning objects (2) relative to a substantially horizontal working surface (5) having a longitudinal extension (3) in the X-direction and a transversal extension (4) in the Y-direction; with the apparatus (1) for moving objects (2) being arranged at least in a Z-direction standing substantially perpendicular to the working surface (5) and comprising at least two toothed racks (8,8′) which extend at an axial direction adjacent to each other in the Z-direction at an axial distance (6) and are provided for receiving an object (2) to be moved each; with said toothed racks (8,8′) being provided with a movable arrangement over a Z-displacement path (9), such that they are in engagement with a pinion (10,10′) of a Z-drive (11) which is each motively driven in an individual fashion and exerts a pressing force on the respective toothed rack (8,8′), with the toothed racks (8,8′) comprising two Z-rails (15,15′) which project laterally in the Y-direction and extend in the Z-direction and which are slidingly held in Z-guide means (16,16′) of an associated cage (17,17′) carrying the individual pinion (10,10′), with the toothed racks (8,8′) being arranged together with the respectively associated cage (17,17′) alternating adjacent to each other along an axis (7) extending in the Y-direction in such a way that the cages (17,17′) are alternatingly situated in front of and behind the axis (7), and with the Z-rails (15,15′) of the similarly oriented toothed racks (8,8′) being each arranged on a line (18,18′) which extends parallel to the axis (7) and between the same and the teeth (19,19′) of the toothed racks (8,8′); with the axial distance (6) of the toothed racks (8,8′) being variable in the Y-direction by means of Y-drives (20) and the toothed rack packet (23) being movable to a compact position with a minimal axial distance (6) which substantially corresponds to the grating distance (12) of wells (13) of a microplate (14). The apparatus in accordance with the invention is characterized in that at least every other toothed rack (8,8′) comprises spacers (21,21′,31,31′,31″) fastened to or arranged on the same, which spacers—for defining the minimum axial distance in the compact position of the toothed rack packet (23)—are abutted by a rail (15′,15, 30,30′) extending in the Z-direction of each of the adjacent racks.

### FIELD OF THE INVENTION

In accordance with the preamble of claim 1, the invention relates to an apparatus for positioning objects relative to a substantially horizontal working surface having a longitudinal extension in the X-direction and a transversal extension in the Y-direction. The apparatus for moving objects is arranged at least in a Z-direction standing substantially perpendicular to the working surface and comprises at least two toothed racks which extend at an axial direction adjacent to each other in the Z-direction and are provided for receiving an object to be moved each. Said toothed racks are provided with a movable arrangement over a Z path of displacement, such that they are in engagement with a pinion of a Z-drive which is each motively driven in an individual fashion and exerts a pressing force on the respective toothed rack. The toothed racks comprise two Z-rails which project laterally in the Y-direction and extend in the Z-direction and which are slidingly held in Z-guide means of an associated cage carrying the individual pinion. The toothed racks are arranged together with the respectively associated cage alternating adjacent to each other along an axis extending in the Y-direction that the cages are alternatingly situated in front of and behind the axis. The Z-rails of the similarly oriented toothed racks are each arranged on a line, which extends parallel to the axis and between the same and the teeth of the toothed racks. The axial distance of the toothed racks can be varied in the Y-direction by means of Y-drives and the toothed rack packet can be brought to a compact position with a minimal axial distance, which substantially corresponds to the grating distance of wells of a microplate.

### DESCRIPTION OF THE PRIOR ART

The working platforms for treating liquids such as the pipetting of liquids from receptacles and the distribution of the same in the wells of a microplate comprise apparatuses of this kind. It has been noticed that the precision with which a pipette tip can be positioned automatically on a conventional working platform for example is insufficient in order to access the wells of a microplate with 1536 wells in a routine manner. In the case of an excessive fault tolerance there is the likelihood that the pipette tip, the temperature sensor, pH-sensor or any other elongated thin object to be positioned in a well is damaged by hitting the walls of the well or the surface of the microplate. Moreover, in the case of a hard impact of such an object with the microplate surface there is the likelihood of a loss of a sample, a contamination of the adjacent samples and the workplace. The precise accessing of the wells where there is no likelihood of any unintentional touching of parts of the microplate is therefore a principal requirement for routinely working with a liquid handling system that can be used e.g., for the automatic examination of blood samples.

### SUMMARY OF THE INVENTION

It is the object of the present invention to provide an apparatus with which the wells of a 1536-well microplate can be routinely precisely accessed by an elongated thin object.

This object is achieved in accordance with the characterizing part of the independent claim 1 in such a way that an aforementioned apparatus is improved in such a way that at least every other toothed rack comprises spacers fastened to or arranged on the same, which spacers—for defining the minimum axial distance in the compact position of the toothed rack packet—are abutted by a rail extending in the Z-direction of each of the adjacent racks. Additional preferred inventive features are shown in the dependent claims.

Measurements of the reproducibility of repeated accessing of certain points in a measuring system corresponding to a microplate have revealed that with the apparatus in accordance with the invention and an axial distance of the pipette tips of 9 mm the fault tolerance is smaller than or equal to +/−100 μm. The requirements for secure accessing of the wells of a 1536-well microplate are thus fulfilled. The object is thus achieved.

### BRIEF DESCRIPTION OF THE DRAWINGS

The apparatus in accordance with the invention is now explained in detail by reference to schematic drawings that do not limit the scope of the invention and show exemplary embodiments, wherein:

FIG. 1 shows a horizontal sectional view through a toothed rack packet of an apparatus according to a first embodiment in accordance with the invention;

FIG. 2A shows a front view of a toothed rack packet of an apparatus according to the first embodiment in accordance with the invention, comprising spacers in a position according to a first variant;

FIG. 2B shows a front view of a toothed rack packet of an apparatus according to the first embodiment in accordance with the invention, comprising spacers in a position according to a second variant;

FIG. 3A shows a front view of a toothed rack packet of an apparatus according to a second embodiment in accordance with the invention, comprising spacers in a position according to a first variant;

FIG. 3B shows a front view of a toothed rack packet of an apparatus according to a third embodiment in accordance with the invention, comprising spacers in a position according to a second variant;

FIG. 4 shows an enlarged view according to FIGS. 2 and 3, with inserted pipette tips and microplates with 96, 384 and 1536 wells;

FIG. 5 shows a schematic 3D view of a system for liquid handling with a working surface and a toothed rack packet of an apparatus in accordance with the invention;

FIG. 6 shows a horizontal sectional view through a toothed rack packet of an apparatus according to a fourth, fifth and sixth embodiment in accordance with the invention;

FIG. 7A shows a front view of the toothed rack packet of an apparatus according to a sixth embodiment in accordance with the invention, comprising additional spacers in a position according to a second variant;

FIG. 7B shows a front view of a toothed rack packet of an apparatus according to a seventh embodiment in accordance with the invention, comprising spacers in a position according to a second variant.

### DESCRIPTION OF THE PREFERRED EMBODIMENTS

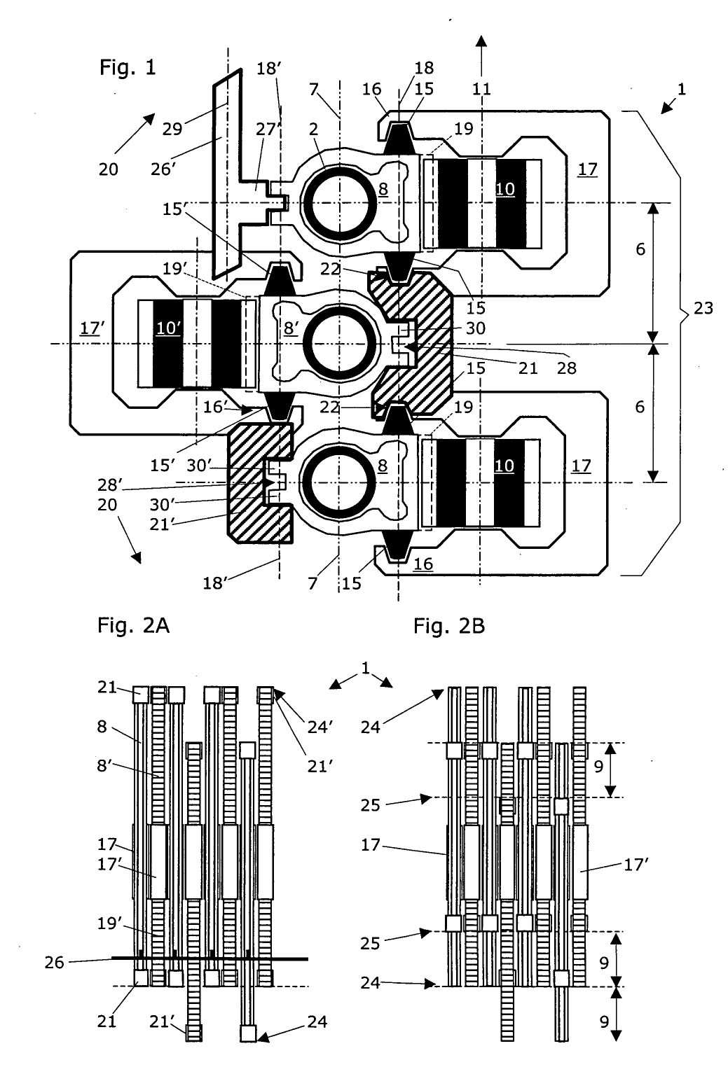

FIG. 1 shows a horizontal sectional view through an apparatus according to a first embodiment in accordance with the invention. Said apparatus 1 is used for positioning objects 2 relative to a substantially horizontal working surface 5 which comprises a longitudinal extension 3 in the X-direction and a transversal extension 4 in the X-direction (also see FIG. 5). The apparatus 1 is arranged for moving the objects 2 in at least one Z-direction standing substantially perpendicular to the working surface 5 and comprises at least two toothed racks 8,8′ for each receiving an object 2 to be moved, which toothed racks extend at an axial distance 6 adjacent to each other in the Z-direction. Objects to be moved are generally elongated and thin and extend in the Z-direction. Typical objects are for example reference tips for mutual setting or aligning microplates and other vessels with respect to a coordinate system of a liquid handling system that comprises a working surface 5. Dispenser tips and pipette tips are such objects, with spray needles also being designated as dispenser tips. Fixed steel hollow needles, disposable tips made of plastic and so-called “ZipTips™” (Millipore Corporation, 80 Ashby Road, Bedford, Mass. 01730-2271, U.S.A.) are designated herein as exemplary pipette tips. Electrodes, temperature sensors, pH-probes and optical fibers also belong to the preferred objects to be positioned.

The toothed racks 8,8′ are provided with a movable configuration over a Z-displacement path 9, such that they are each in engagement with a motively individually driven pinion 10,10′ of a Z-drive 11, which pinion exerts a pressing force on the respective toothed rack 8,8′. The toothed racks 8,8′ comprise two Z-rails 15,15′ which project laterally in the Y-direction and extend in the Z-direction and which are slidingly arranged in Z-guide means 16,16′ of an associated cage 17,17′ carrying the individual pinion 10,10′.

The toothed racks 8,8′ are arranged together with the respectively associated cage 17,17′ next to one another alternatingly along an axis 7 extending in the Y-direction, so that the cages 17,17′ come to lie alternatingly before or behind the axis 7. The Z-rails 15,15′ of the similarly oriented toothed racks 8,8′ are each arranged on a line 18,18′ each which extends parallel to the axis 7 and between the same and the teeth 19,19′ of the toothed racks 8,8′.

The axial distance 6 of the toothed racks 8,8′ can be varied in the Y-direction by means of Y-drives 20 and the toothed rack packet 23 can be brought to a compact position with a minimum axial distance 6 which substantially corresponds to the grating distance 12 of wells 13 of a microplate 14 (see FIG. 4). Preferably, two motors are used as Y-drives.

In a simple first embodiment of the apparatus in accordance with the invention, at least every other toothed rack 8,8′ comprises spacers 21,21′,31,31′,31″ which are fastened thereto or arranged thereon and which spacers 21,21′,31,31′,31″—for defining the minimum axial distance 6 in the compact position of the toothed rack packet 23—are abutted by a rail 15′,15, 30,30′ extending in the Z-direction of each of the adjacent racks 8,8′. The spacers 21,21′ are preferably arranged in such a way that they can be only be abutted from both sides by a Z-rail of an adjacent rack. In an improved first embodiment of an apparatus in accordance with the invention, each toothed rack 8,8′ comprises spacers 21,21′ which are fastened thereto or arranged thereon, and which are pressed in the compact position of the toothed rack packet 23 with a Z-rail 15,15′ of the adjacent racks 8,8′ for defining the minimum axial distance 6.

FIG. 2 shows in front views of toothed rack packets an apparatus according to the first embodiment in accordance with the invention: The spacers 21,21′ are provided with a cuboid configuration for forming a linear contact with a Z-rail 15′,15. Preferably, the spacers 21,21′ are arranged as fixed elements which are slidingly pressable by the Z-rails 15′,15 of the adjacent racks 8′,8.

FIG. 2A shows this embodiment with spacers in a position according to a first variant: In order to enable the highest possible movement of the toothed racks 8,8′ in the Z-direction, the spacers 21,21′ are preferably arranged in the region of the ends 24,24′ of the toothed racks 8,8′.

FIG. 2B shows this embodiment with spacers in a position according to a second variant: In order to ensure the mutual pressing of virtually all spacers 21,21′ and Z-rails 15,15′ permanently, the spacers 21,21′ are arranged away from the ends 24,24′ by least almost the amount of the Z-displacement path 9 of the toothed racks 8,8′. This variant leads to the disadvantage however that the total Z-displacement path 9 is slightly reduced. An arrangement of the spacers in an intermediate region (cf. claim 12) might represent an advantageous compromise.

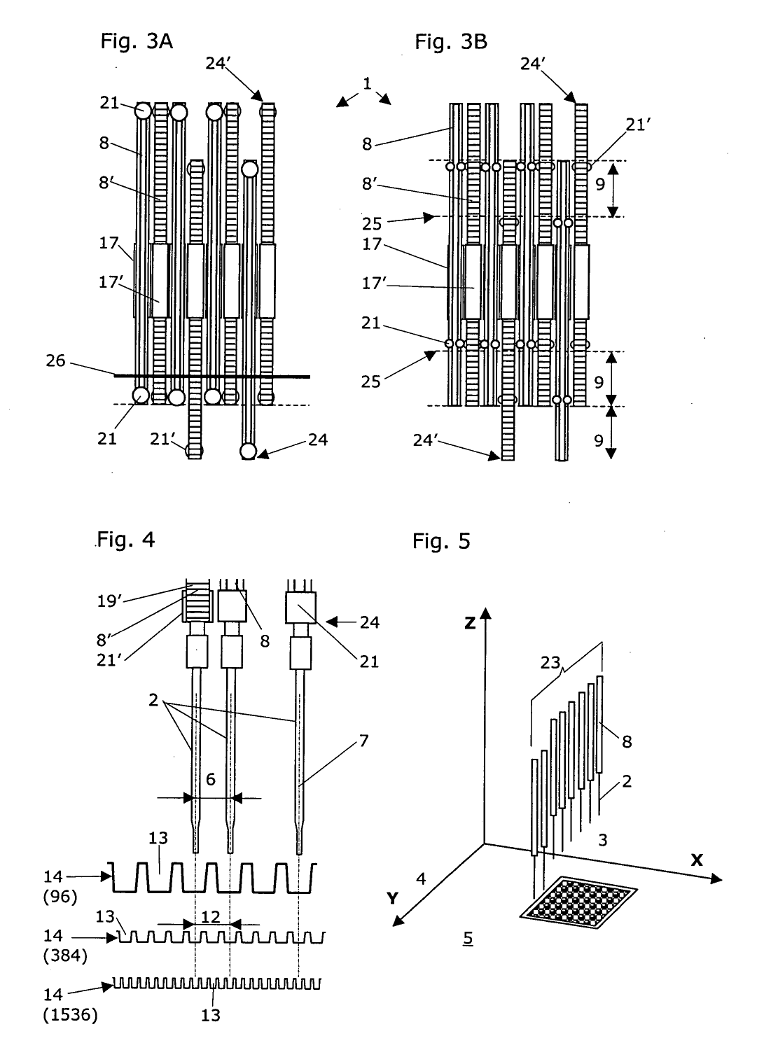

FIG. 3A shows a front view of a toothed rack packet with spacers of a second embodiment in accordance with the invention in which the spacers 21,21′ are provided with a cylindrical arrangement in order to form a point contact with a Z-rail 15′,15: In order to ensure the largest possible movement of the toothed racks 8,8′ in the Z-direction, the spacers 21,21′ are preferably arranged in the region of the ends 24,24′ of the toothed racks 8,8′. The fixed cylinders are situated in the position of the spacers 21,21′ corresponding to FIG. 2A in a position according to a first variant. Departing from this representation it is also possible to choose an oval or other bent surface of the spacers, which deviates from the cylindrical shape.

FIG. 3B shows a front view of a toothed rock packet with spacers of a third embodiment in accordance with the invention in which the spacers 21,21′ are provided with a rotatable and roll-like arrangement for forming a point contact with a Z-rail 15′,15. The spacers 21,21′ which are arranged as rotatable roller elements are situated in a position according to a second variant: In order to ensure the mutual pressing of virtually all spacers 21,21′ and Z-rails 15,15′ permanently, the spacers 21,21′ are arranged away from the ends 24,24′ by at least almost the amount of the Z-displacement path 9 of the toothed racks 8,8′. This variant leads to the disadvantage however, that the total Z-displacement path 9 is slightly reduced. An arrangement of the spacers in an intermediate region (cf. claim 12) might represent an advantageous compromise.

As an alternative to these representations with fixed spacers according to FIG. 2 or rotatable spacers according to FIG. 3 which all assume a fixed position on the toothed racks 8,8′, displaceable spacers 21,21′ according to claim 13 can be provided. They would not limit the Z displacement path 9. Instead, they would add additional tolerance to the system, so that the guidance of the Z-rails 15′,15 would be slightly less precise.

The spacers 21,21′ which were described above and on the basis of FIGS. 2 and 3 comprise recesses 22,22′ (cf. FIG. 1) which preferably extend in the Z-direction and which are adjusted to the profile of the Z-rails 15′,15 of the adjacent racks, so that said Z-rails 15′,15 rest substantially free from play in said recesses 22,22′ when the packet 23 of the toothed racks 8,8′ is situated in the compact position with minimum axial distance 6.

Combs 26,26′ have been additionally entered in the FIGS. 2A and 3A which can be comprised by the apparatus 1 preferably additionally or as an alternative to the shown spacers 21,21′. Said combs 26,26′ extend substantially in the Y-direction and comprise fingers 27,27′ which with respect to their dimension are adjusted at least partly to the intermediate spaces 28,28′ of the toothed racks 8,8′ extending in the Z-direction and which engage in said intermediate spaces 28,28′ by a rotating of the combs 26,26′ about their axis 29,29′. Said rotation may occur manually or in a motively driven manner and can be executed by computer control. Alternatively, a comb can be inserted manually. After turning in the fingers 27,27′ of said combs 26,26′, all included toothed racks 8,8′ are mutually blocked at least in the Y-direction and can be lowered or lifted preferably jointly or individually with very little play. By using such a comb 26,26′, the individual displaceability in the Z-direction of the toothed racks which is given otherwise by the embodiments according to FIGS. 2 and 3 is optionally removed. This removal of the individual displaceability in the Z-direction is only produced when the fingers engage in an absolutely play-free manner in the U-rails or in the spaces between the toothed racks. The fixedly set axial distance 6 of the toothed racks 8,8′ in the compact position of the toothed rack packet 23 substantially corresponds to the grating distance 12 of the wells 13 of a microplate 14 with 96, with 384 or with 1536 wells. For production reasons, the grating distance of a 96-well plate of 9 mm is preferably chosen as the smallest axial distance 6.

FIG. 4 shows an enlarged view according to FIGS. 2 and 3, with inserted pipette tips 2 and microplates 14 with 96, 384 and 1536 wells. It is clearly shown that the apparatus 1 can reach all wells 13 of a 96-well plate simultaneously and without having to displace the toothed racks 8,8′ in the X- or Y-direction. As a resuit of the reduced grating distance 12 of the wells 13, only every other well, i.e. all even or uneven numbers, is hit simultaneously with an apparatus 1 with a minimum axial distance 6 of 9 mm in a 384-well plate. In the case of a 1536-well microplate, this will only be every fourth well, i.e. the wells 1, 5, 9, etc. Without using a comb 26,26′, i.e. in the case of full individual mobility of all toothed racks 8,8′, a defined force in the positive and negative Y-direction is permanently exerted on the toothed racks 8,8′ preferably by a Y-drive 20 which comprises two drive motors (not shown) and which acts from two sides upon the toothed rack packet 23, so that the toothed racks 8,8′ press in the compact position from both sides.

In any case, one or several apparatuses 1 are preferably integrated in a liquid handling system with at least one working surface 5 which comprises at least one or several processors for controlling all necessary movements of the toothed racks. FIG. 5 shows a schematic 3D view of such a system for liquid handling with a working surface 5 and an apparatus 1 in accordance with the invention. The allocation of the axes X and Y, which are rectangular with respect to each other, is random and can also be exchanged. The allocation of the Z-axis, which is perpendicular to the working surface 5, defined by X and Y is unchangeable.

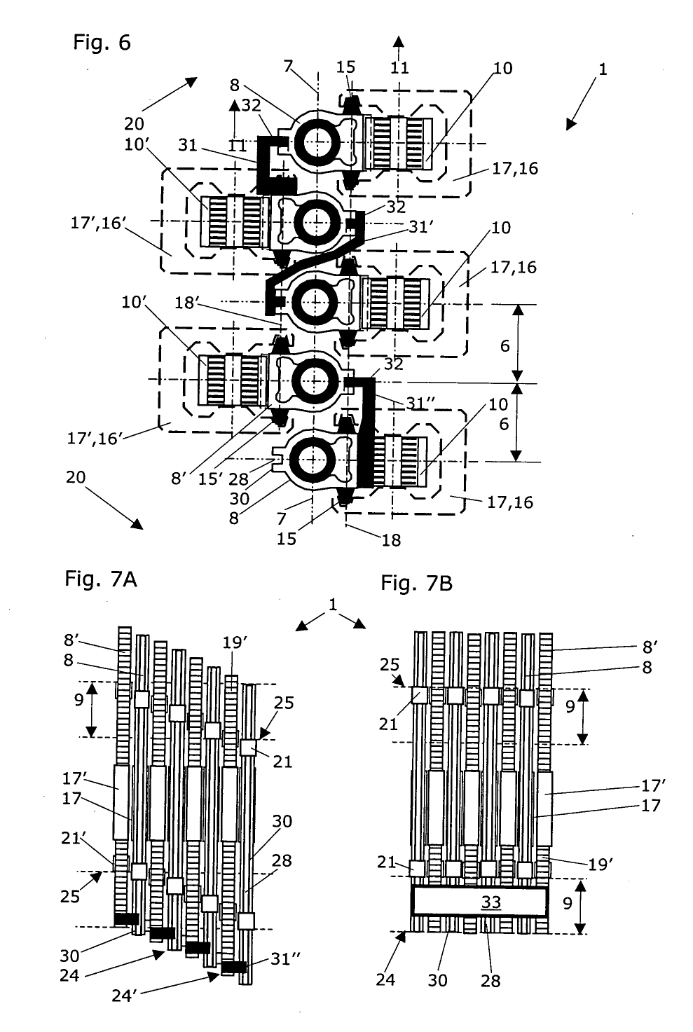

FIG. 6 shows a horizontal sectional view through a toothed rack packet of an apparatus 1 according to a fourth, fifth and sixth embodiment in accordance with the invention. In any case, each toothed rack 8,8′ comprises spacers 31,31′,31″ which are fastened to or arranged on the same and which in the compact position of the toothed rack packet 23 are pressed in engagement with a U-rail 30,30′ of the adjacent racks 8′,8 for defining the minimum axial distance 6. Moreover, said embodiments are preferably provided with additional spacers 21,21′ in a position according to a second variant for the purpose of additionally reducing the play of the toothed racks among each other (cf. FIG. 2B).

According to a fourth embodiment, the spacer 31 has the shape of a “C”, with one leg of said “C” being fastened laterally to the toothed rack 8′ and the other leg engaging in the intermediate space 28 of the U-rail 30 of the adjacent rack 8 extending in the Z-direction.

According to a fifth embodiment, the spacer 31′ has the shape of a “Z”, with one leg of said “Z” being fastened in the region of the U-rail 30 of the toothed rack 8 and the other leg engaging in the intermediate space 28 of the U-rail 30 of the adjacent rack 8′ extending in the Z-direction.

According to the sixth embodiment, the spacer 31″ has the shape of an “L”, with the large leg of said “L” being fastened in the region of the teeth 19 of the toothed rack 8 and the short leg engaging in the intermediate space 28 of the U-rail 30 of the adjacent rack 8′ extending in the Z-direction.

FIG. 7A shows a front view of the toothed rack packet of an apparatus according to a sixth embodiment in accordance with the invention. The spacers 31″ are arranged close to the lower end of the toothed racks 8,8′, so that the locking of the toothed racks to be produced by these spacers occurs as far down as possible and remote from the cages 17,17′ with the Z-guide means 16,16′ which are immobile in the Z-direction. The individual toothed racks 8,8′ of the packet 23 are situated in a staggered Z-position in which an access opening (not shown) for the short leg of the “L”-shaped spacer 31″ in the U-rails 30 can be accessed by reducing the axial distance 6 in the Y-direction. For latching the toothed racks among each other, the toothed racks are then lowered to the same Z-position, so that the short leg of the “L”-shaped spacer 31″ engages between the two U-rails 30 that are present here. Now all locked toothed racks 8,8′ can be lifted or lowered with each other. The spacers 21,21′ additionally reduce the play of the toothed racks among each other. In the staggered position, the toothed racks 8,8′ can be controlled again and motively driven, i.e. they can be separated from each other in an automated manner, such that the axial distance 6 of the toothed racks 8,8′ is increased. The apparatus 1 thus comprises spacers 31,31′,31″ with retaining webs 32 which can be moved in a certain mutual Z-position of two adjacent toothed racks 8,8′ into the intermediate space 28,28′ of the U-rail 30′,30 of the adjacent rack 8′,8.

Departing from the previously described fourth, fifth and sixth embodiment, the U-rail 30,30′ to be passed through with retaining web 32 of the spacers 31,31′,32″ can be omitted to the extent that only the lowermost portion is present which corresponds in its dimension to the retaining web 32. This leads to the advantage that the toothed racks can be moved with the fixedly mounted spacers 31,31′,31″ with the highest possible freedom independent from each other.

FIG. 7B shows a front view of the toothed rack packet of an apparatus according to a seventh embodiment in accordance with the invention, with spacers in a position according to a second variant. All toothed racks to be locked with each other are mutually connected by a massive plate 33. This leads to the advantage that the toothed racks are joined with each other in the lower problematic region in a precise and immobile manner. It may be disadvantageous that the plate 33 needs to be mounted and dismounted by hand. Moreover, this embodiment preferably provides additional spacers 21,21′ in a position according to a second variant for additionally reducing the play of the toothed racks among each other (cf. FIG. 2B).

Departing from the shown and described representations, the toothed racks 8,8′ can also receive multiple objects. For example, these can be multiple pipettes that comprise two or more tips which are successively lined up in a comblike manner in one row in the X-direction, i.e. rectangular to the axis 7. The same also applies to the other objects to be received by the toothed racks such as reference tips, dispenser tips, pipette tips, electrodes, temperature sensors, pH-probes, optical fibers and similar elongated objects.

The effective principle of the Z-rails 15,15′ and Z-guide means 16,16′ can be reversed, such that the cages 17,17′ comprise shorter Z-rails which slide into the Z-guide means 16,16′ which are attached to the toothed rods 8,8′. Generally, the Z-rails 15,15′ and the spacers 21,21′,31,31′,31″ can be produced in an integral way with the toothed rods 8,8′ or can be fastened to the same. A combination of the spacers 21,21′ with other equipment parts on the toothed rods 8,8′ not yet shown is also possible.

Preferably, the apparatus 1 comprises a sensor device (not shown) that indicates or informs the computer control unit whether the toothed rack packet 23 is locked or not. It can thus be prevented that the Y-drives 20 are given a command by the operator or an automatic control unit that the axial distance 6 of the toothed racks 8,8′ is to be changed.

### List of Reference Numerals

| | |
|---|---|
| 1 | Apparatus |
| 2 | Objects |
| 3 | Longitudinal extension |
| 4 | Transversal extension |
| 5 | Working surface |
| 6 | Axial distance |
| 7 | Axis |
| 8, 8′ | Toothed racks |
| 9 | Z-displacement path |
| 10, 10′ | Pinion |
| 11 | Z-drive |
| 12 | Grating distance |
| 13 | Wells |
| 14 | Microplate |
| 15, 15′ | Z-rails |
| 16, 16′ | Z-guide means |
| 17, 17′ | Cage |
| 18, 18′ | Line |
| 19, 19′ | Teeth |
| 20 | Y-drives |
| 21, 21′ | Spacers |
| 22, 22′ | Recesses |
| 23 | Toothed rack packets |
| 24, 24′ | Toothed rack ends |
| 25 | Points spaced by 9 |
| 26, 26′ | Combs |
| 27, 27′ | Fingers |
| 28, 28′ | Intermediate spaces |
| 29, 29′ | Axis of the combs |
| 30 | U-rail |
| 31, 31′31″ | Spacers |
| 32 | Retaining webs |
| 33 | Plate |

What is claimed is:

1. An apparatus for positioning objects relative to a substantially horizontal working surface having a longitudinal extension in the X-direction and a transversal extension in the Y-direction; with the apparatus for moving objects being arranged at least in a Z-direction standing substantially perpendicular to the working surface and comprising at least two toothed racks which extend at an axial direction adjacent to each other in the Z-direction at an axial distance and are provided for receiving an object to be moved each; with said toothed racks being provided with a movable arrangement over a Z-displacement path, such that they are in engagement with a pinion of a Z-drive which is each motively driven in an individual fashion and exerts a pressing force on the respective toothed rack, with the toothed racks comprising two Z-rails which project laterally in the Y-direction and extend in the Z-direction and which are slidingly held in Z-guide means of an associated cage carrying the individual pinion, with the toothed racks being arranged together with the respectively associated cage alternating adjacent to each other along an axis extending in the Y-direction in such a way that the cages are alternatingly situated in front of and behind the axis, and with the Z-rails of the similarly oriented toothed racks being each arranged on a line which extends parallel to the axis and between the same and the teeth of the toothed racks; with the axial distance of the toothed racks being variable in the Y-direction by means of Y-drives and the toothed rack packet being movable to a compact position with a minimal axial distance which substantially corresponds to the grating distance of wells of a microplate,
wherein at least every other toothed rack comprises spacers fastened thereto or arranged thereon and which spacers—for defining the minimum axial distance in the compact position of the toothed rack packet—are abutted by a rail extending in the Z-direction of each of the adjacent racks.

2. The apparatus of claim 1,
wherein each toothed rack comprises spacers, which are arranged thereon, and which are pressed in the compact position of the toothed rack packet with a Z-rail each of the adjacent racks for defining the minimum axial distance.

3. The apparatus of claim 1,
wherein each toothed rack comprises spacers, which are arranged thereon, and which are pressed in engagement in the compact position of the toothed rack packet with an U-rail of the adjacent racks for defining the minimum axial distance.

4. The apparatus of claim 1,
wherein the spacers are arranged as fixed elements, which are slidingly pressable, by the Z-rails of the adjacent racks.

5. The apparatus of claim 4,
wherein the spacers are provided with a cuboid configuration for forming a linear contact with a Z-rail.

6. The apparatus of claim 4,
wherein the spacers are provided with a cylindrical arrangement in order to form a point contact with a Z-rail.

7. The apparatus of claim 1,
wherein the spacers are arranged as roller elements, which can be pressed by the Z-rails of the adjacent racks.

8. The apparatus of claim 4,
wherein the spacers comprise recesses which extend in the Z-direction and which are adjusted to the profile of the Z-rails of the adjacent racks, so that said Z-rails rest substantially free from play in said recesses when the packet of the toothed racks is situated in the compact position with minimum axial distance.

9. The apparatus of claim 1,
wherein the spacers comprise retaining webs, which can be moved in a certain mutual Z-position of two adjacent toothed racks into the intermediate space of an U-rail of the adjacent rack.

10. The apparatus of claim 1,
wherein the spacers are preferably arranged in the region of the ends of the toothed racks.

11. The apparatus of claim 1,
wherein the spacers are arranged away from the ends of said toothed racks at least by approximately the amount of the Z-displacement path of the toothed racks.

12. The apparatus of claim 1,
wherein the spacers are arranged in the region between the ends of the toothed racks and points, which are distanced, by the amount of the Z-displacement path of the toothed racks from their ends.

13. The apparatus of claim 1,
wherein the spacers are displaceable at least over a part of the length of the toothed racks.

14. The apparatus of claim 1,
wherein it comprises combs which extend substantially in the Y-direction, with said combs comprising fingers which with respect to their dimension are adjusted at least partly to the intermediate spaces of the toothed racks extending in the Z-direction or to spaces located between the toothed racks, and which engage in said intermediate spaces by rotating the combs about their axis or by manual insertion of the same into said intermediate spaces.

15. The apparatus of claim 1,
wherein the Y-drive acts from two sides upon the toothed rack packet and is configured in such a way that in the compact position of the toothed racks it permanently exerts from both sides a defined force in the Y-direction upon the toothed racks.

16. The apparatus of claim 1,
wherein the axial distance of the toothed racks corresponds to the grating distance of the wells of a microplate with 96, with 384 or with 1536 wells in the compact position of the toothed rack packet.

17. The apparatus of claim 1,
wherein the objects are chosen from a group comprising reference tips, dispenser tips, pipette tips, electrodes, temperature sensors, pH-probes and optical fibers.

18. A liquid handling system with at least one working surface,
wherein it comprises at least one apparatus according to claim 1.
